(19) United States
(12) Patent Application Publication
(10) Pub. No.: US 2026/0039390 A1
(43) Pub. Date: Feb. 5, 2026

(54) OPTICAL TRANSMITTER AND TIMING ADJUSTMENT METHOD

(71) Applicant: Fujitsu Limited, Kawasaki-shi (JP)

(72) Inventors: Yohei SOBU, Shinagawa (JP); Toshihiko MORI, Isehara (JP)

(73) Assignee: Fujitsu Limited, Kawasaki-shi (JP)

(21) Appl. No.: 19/354,310

(22) Filed: Oct. 9, 2025

Related U.S. Application Data
(63) Continuation of application No. PCT/JP2024/009283, filed on Mar. 11, 2024.

(30) Foreign Application Priority Data
Apr. 11, 2023 (JP) 2023-064525

(51) Int. Cl. H04B 10/516; H04L 7/00

(52) U.S. Cl. CPC H04B 10/516; H04L 7/0075

(57) ABSTRACT

An optical transmitter includes: an optical modulator that modulates an optical signal, and has three or more segments arranged along one or both optical waveguides of a Mach-Zehnder interferometer, two or more types of input bit data being input to the segments of the optical modulator; an encoder that obtains bit data for multiple bits by converting the input bit data to code for modulation performed by the optical modulator, the encoder outputting the obtained bit data to any of the segments; a switch that switches the bit data output by the encoder to a different one of the segments; a delay adjusting unit that adjusts delay between the segments; and a controller that instructs the switch to switch the bit data to the different one of the segments and notifies the switch of an amount of delay for the delay adjusting unit, based on monitoring of the optical signal modulated by the optical modulator.

### CROSS REFERENCE TO RELATED APPLICATIONS

This is a continuation application of International Application PCT/JP2024/009283 filed on Mar. 11, 2024 which claims priority from a Japanese Patent Application No. 2023-064525 filed on Apr. 11, 2023, the contents of which are incorporated herein by reference.

### FIELD

Embodiments discussed herein relate to an optical transmitter and a timing adjustment method.

### BACKGROUND

A typical optical transmitter in a high-capacity transmission system, such as a digital coherent transmission scheme or an intensity modulation with direct detection (IM-DD) scheme, converts a digital signal output from a digital signal processor (DSP) into an electrical analog signal using an electrical digital-to-analog converter (DAC), amplifies the electrical analog signal using an analog driver to generate a drive signal with an amplitude of several volts, and drives a traveling-wave optical modulator to generate a multilevel-modulated optical signal.

In relation to this, to reduce the power consumption of optical transmitters, an optical digital-to-analog converter (DAC) technique has been researched as an architecture for generating multilevel-modulated optical signals by directly inputting digital signals into a segmented optical modulator (an optical modulator having multiple phase shifters coupled in multiple stages on an optical waveguide).

The optical DAC technique optically converts digital signals into analog signals by amplifying, using a binary driver, a drive signal generated from a digital signal for bits corresponding to a symbol and inputting the amplified signal directly into a segmented lumped-element optical modulator. This eliminates the need to convert digital signals into analog signals using the electrical DAC and output large-amplitude drive signals from a linear driver, which is expected to reduce power consumption.

On the other hand, in optical DACs, because the optical modulator has multiple segments (phase shifters) and converts digital signals into analog signals in the optical domain, proper timing adjustment between the optical signal propagating through the segments and the digital signal input from the binary driver is necessary to achieve good signal quality.

Factors that cause timing discrepancies between multiple segments of an optical DAC include: 1. delays caused by unequal lengths of electrical signal wiring between multiple segments; 2. propagation delays of optical signals between multiple segments; and 3. dynamic variations in delay amount due to temperature changes, etc. Of the above, for 1. unequal lengths of electrical signal wiring and 2. propagation delays of optical signals, timing adjustments are expected to be performed as fixed delay amounts through calibration at the time of factory shipment or after device installation. Furthermore, during operation, for 3. dynamic fluctuations in delay amount due to temperature changes, etc., a timing adjustment method for delay amounts that vary over time, such as voltage fluctuations and temperature fluctuations during device operation, is necessary.

Prior art related to delay adjustment, for example, involves monitoring the output light of an optical modulator and detecting a discrepancy between the timing of an input drive signal and the optical propagation time between two segments arranged on the same optical waveguide, based on the amplitude value of the monitored signal. There is also a technique for controlling the timing of the drive voltage applied to each of multiple segments of the optical waveguide in two arms of a Mach-Zehnder-type segmented optical modulator, based on the intensity (average power) of the light output from the optical modulator. Prior art related to optical DACs includes a technique for dividing the segments of an optical modulator according to the input bits and outputting bit data from least significant bits (LSB) to most significant bits (MSB) to multiple segments (phase shifters) of the corresponding optical waveguide, to thereby output a multilevel optical signal. For example, refer to International Publication No. WO2013/140482, International Publication No. WO2014/103231, and U.S. Pat. No. 7,787,713.

### SUMMARY

According to an aspect of an embodiment, an optical transmitter includes: an optical modulator that modulates an optical signal, the optical modulator having three or more segments arranged in series along one or both of two optical waveguides of a Mach-Zehnder interferometer, two or more types of input bit data being input to the three or more segments of the optical modulator; an encoder that obtains bit data for a plurality of bits by converting the input bit data to code for optical modulation performed by the optical modulator, the encoder outputting the obtained bit data to any of the three or more segments; a switch that switches the bit data output by the encoder to a different one of the three or more segments; a delay adjusting unit that adjusts an amount of delay between the three or more segments; and a controller that instructs the switch to switch the bit data output by the encoder to the different one of the three or more segments and notifies the switch of an amount of delay for the delay adjusting unit, based on monitoring of the optical signal optically modulated by the optical modulator.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a block diagram depicting an example of a function of a 3-bit input optical DAC disposed in an optical transmitter according to an embodiment.

FIG. 1B is a diagram depicting a configuration example of an optical DAC according to the embodiment.

FIG. 2 is an explanatory diagram of factors that cause delays in optical DACs.

FIG. 3 is an explanatory diagram of an example of dynamic timing adjustment.

FIG. 4AA is a diagram depicting an example of waveform degradation due to the presence or absence of signal delay.

FIG. 4AB is a diagram depicting an example of waveform degradation due to the presence or absence of signal delay.

FIG. 4BA is a diagram depicting an example of waveform degradation due to the presence or absence of signal delay.

FIG. 4BB is a diagram depicting an example of waveform degradation due to the presence or absence of signal delay.

FIG. 4C is a graph depicting a relationship between the delay difference between segments receiving the same data and the monitored optical power.

FIG. 5A is an explanatory diagram of an example of timing adjustment for an optical DAC according to the embodiment.

FIG. 5B is an explanatory diagram of an example of timing adjustment for the optical DAC according to the embodiment.

FIG. 6 is a diagram depicting an example of a hardware configuration of a controller of the optical DAC.

FIG. 7 is a functional block diagram depicting a configuration example of an optical DAC according to a first example.

FIG. 8 is a flowchart of a first example of timing adjustment processing by the optical DAC of the first example.

FIG. 9A is a diagram depicting an example of combination states of bits and segments in the first example of timing adjustment processing of the first example.

FIG. 9B is a diagram depicting an example of combination states of bits and segments in the first example of timing adjustment processing of the first example.

FIG. 10 is a flowchart of a second example of timing adjustment processing by the optical DAC of the first example.

FIG. 11A is a diagram depicting combination states of bits and segments in a second example of timing adjustment processing of the first example.

FIG. 11B is a diagram depicting combination states of bits and segments in a second example of timing adjustment processing of the first example.

FIG. 12 is a flowchart depicting a first specific processing example of timing adjustment.

FIG. 13 is a flowchart depicting a second specific processing example of timing adjustment.

FIG. 14 is a functional block diagram depicting a configuration example of an optical DAC of a second example.

FIG. 15 is a circuit diagram depicting an example of a configuration of an optical DAC switch of the second example.

FIG. 16 is a diagram depicting an example of a configuration of a multi-stage arrangement of switches in the optical DAC according to the second example.

FIG. 17 is a flowchart of a first example of timing adjustment processing by the optical DAC of the second example.

FIG. 18A is a diagram depicting the switching states of bit and segment combinations in the first example of timing adjustment processing of the second example.

FIG. 18B is a diagram depicting the switching states of bit and segment combinations in the first example of timing adjustment processing of the second example.

FIG. 18C is a diagram depicting the switching states of bit and segment combinations in the first example of timing adjustment processing of the second example.

FIG. 18D is a diagram depicting the switching states of bit and segment combinations in the first example of timing adjustment processing of the second example.

FIG. 18E is a diagram depicting the switching states of bit and segment combinations in the first example of timing adjustment processing of the second example.

FIG. 19 is a flowchart of a second example of timing adjustment processing by the optical DAC of the second example.

FIG. 20A is a diagram depicting a bit and segment combination state in the second example of timing adjustment processing of the second example.

FIG. 20B is a diagram depicting a bit and segment combination state in the second example of timing adjustment processing of the second example.

FIG. 21 is a diagram depicting a third example of timing adjustment processing using the optical DAC in the second example.

FIG. 22 is a diagram depicting an example of switching timing detection by the optical DAC in the second example.

FIG. 23 is a diagram depicting an example of a configuration of an optical DAC with a coherent configuration.

### DESCRIPTION OF EMBODIMENTS

First, problems associated with the conventional techniques are discussed. When application of a technique related to timing adjustment of conventional segmented optical modulators to an optical DAC transmitter is considered, it is possible to adjust the fixed delay amount between the two segments as an initial calibration. However, no effective way for adjusting timing between segments during device operation has been proposed.

Conventional timing adjustment techniques determine an optimal delay amount, based on the optical output when the same data string is input to a pair of segments. Meanwhile, during optical DAC operation, different data is input to multiple segments. It has not been possible during device operation to adjust the timing between segments to which different data strings are input. For example, in a segment optical modulator used in an optical DAC transmitter, the most significant bits (MSB) and the least significant bits (LSB) are assigned to separate segments within the optical modulator. During device operation, different data is continuously input to each segment for each bit, making it impossible to adjust the timing between, for example, the MSB segment and the LSB segment.

Embodiments of an optical transmitter and a timing adjustment method according to the present disclosure are described in detail with reference to the accompanying drawings.

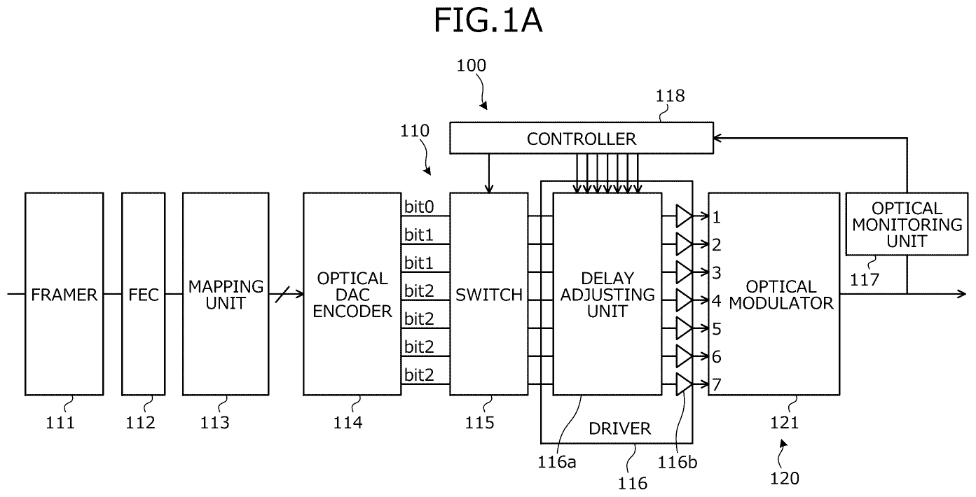

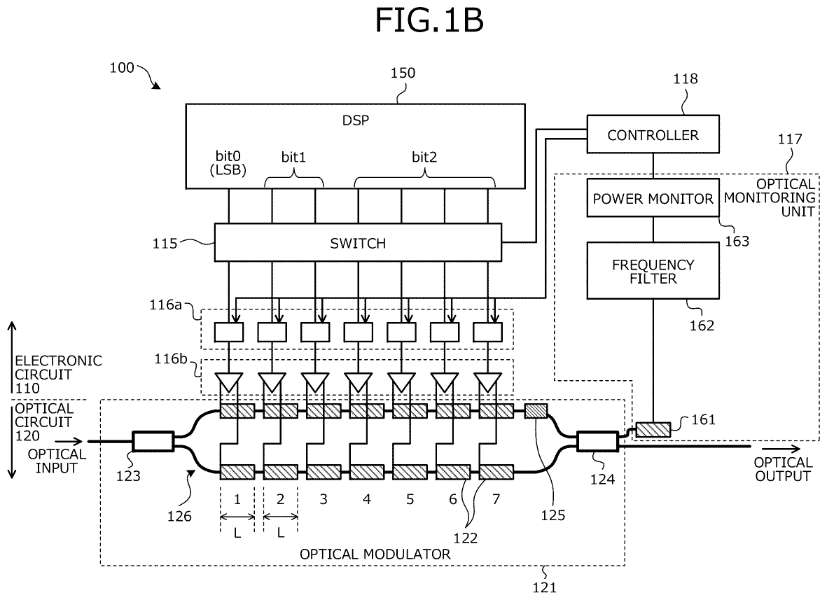

FIG. 1A is a block diagram depicting an example of a function of a 3-bit input optical DAC disposed in an optical transmitter according to an embodiment. The optical transmitter maps transmission data to symbols using a multilevel modulation method such as QAM and inputs a digital signal for bits corresponding to a symbol into a segment (phase shifter) of the optical modulator and thereby, performs digital/analog conversion optically and outputs a modulated optical signal. While digital coherent transmission typically uses an IQ optical modulator to generate an optical transmission signal, for the sake of simplicity, only the I-side optical modulator is depicted in the present description of the present disclosure.

FIG. 1A depicts an optical DAC for which 3-bit input is assumed. An optical DAC 100 includes, for example, an electronic circuit 110 such as a DSP and an optical circuit 120 such as an optical modulator 121. The optical DAC 100 described in the embodiment outputs an optical signal based on two or more types of input bit data input to a segment of the optical modulator 121.

The optical modulator 121 has multiple segments (phase shifters) within a single Mach-Zehnder modulator. A specific segment is designated by the reference numeral 122 in FIG. 1B, but in FIG. 1A, there are seven, as indicated by the number of the input portion of the optical modulator 121. By inputting different digital (electrical signal) bit data from the electronic circuit 110 to the multiple segments of the optical modulator 121, a multi-valued optical signal is output from the optical circuit 120.

The optical DAC 100 of the embodiment controls changing the combinations of bits of digital data input to the optical modulator 121 and the segments assigned to the input data. The optical DAC 100 then adjusts the timing of all segments during device operation (data transmission) by performing timing adjustment based on the monitoring results of the optical signal each time the combinations of data and segments are changed.

In the configuration example depicted in FIG. 1A, the electronic circuit 110 includes, for example, a framer 111, an FEC 112, a mapping unit 113, an optical DAC encoder 114, a switch 115, a driver 116, an optical monitoring unit 117, and a controller 118.

The framer 111 stores input data such as input packets in an optical transport network (OTN) or the like, and generates predetermined transmission data. The FEC 112 encodes the transmission data, adds parity bits for error correction, and outputs the encoded data to the mapping unit 113. The mapping unit 113 generates a symbol signal by mapping the transmission data onto an IQ plane according to a multilevel modulation method such as QAM, and outputs the symbol signal to the optical DAC encoder 114.

The optical DAC encoder 114 converts the input symbol signal into a data code according to the segment configuration of the optical modulator 121. The optical DAC 100 depicted in FIG. 1A is an example of a 3-bit, 7-segment configuration. In this optical DAC 100, the optical modulator 121 has a total of 7 segments, with the LSB bit 0 assigned to 1 segment, bit 1 assigned to 2 segments, and the MSB bit 2 assigned to 4 segments. Corresponding to this assignment, the optical DAC encoder 114 outputs 1 bit of data for bit 0, 2 for bit 1, and 4 for bit 2.

The controller 118 controls the switch 115 when adjusting the timing of each segment. The switch 115 may arbitrarily change the assignment of the bit data of bits 0 to 2 output by the optical DAC encoder 114 and the segments #1 to #7 of the optical modulator assigned to that bit data. The switch 115 changes the assignment of data and segments under the control of the controller 118. The controller 118 adjusts the timing based on the output optical signal of the optical modulator after the assignment change.

The driver 116 includes a delay adjusting unit 116a and a binary driver array 116b. The delay adjusting unit 116a adjusts the timing between the multiple segments 122 under the control of the controller 118. The binary driver array 116b outputs drive signals (bit data) for each of the seven segments of the optical modulator 121.

FIG. 1B is a diagram depicting a configuration example of an optical DAC according to the embodiment. FIG. 1B mainly depicts a configuration example of an optical circuit 120, and components similar to those in FIG. 1A are designated by the same reference numerals used in FIG. 1A. Functions of the framer 111 to the optical DAC encoder 114 described in FIG. 1A may be realized, for example, using a DSP 150 depicted in FIG. 1B. Herein, description will be made with reference to FIGS. 1A and 1B.

As depicted in FIG. 1B, the optical circuit 120 includes an optical waveguide 126 formed on a substrate. The optical modulator 121 of the optical circuit 120 includes the multiple segments (phase shifters) 122, a demultiplexer 123, a multiplexer 124, and a DC phase shifter 125 arranged along the optical waveguide 126.

The optical modulator 121 is, for example, a Mach-Zehnder modulator. A carrier wave emitted from a light source is branched by the demultiplexer 123, to two optical waveguides 126 forming an interferometer. Multiple signal electrodes arranged along the two optical waveguides 126 correspond to multiple segments 122. The light modulated by each segment 122 is combined by the multiplexer 124 and output as a modulated optical signal. One of the optical waveguides 126 includes the DC phase shifter 125 for DC bias control, whereby the operating point of the Mach-Zehnder interference is controlled.

The optical monitoring unit 117 monitors the power of the optical signal output by the optical modulator 121 and outputs the monitoring result to the controller 118. For example, the optical monitoring unit 117 depicted in FIG. 1B includes a monitor photodetector (PD) 161 that converts an optical signal into an electrical signal and a frequency filter 162 that extracts high-frequency components from the electrical signal. A power monitor 163 detects the optical power output from the frequency filter 162 and outputs the result to the controller 118. The optical signal output to the monitor PD 161 may be obtained using a tap on the output of the multiplexer 124 or one of the outputs of a 2×2 multimode interference (MMI) coupler.

The controller 118 controls the switch 115 and the delay adjusting unit 116a. The controller 118 controls the switch 115 to change the combinations of data and the segments 122. For example, the switch 115 switches between the four most significant bits (MSBs) of data of bit 2 (a bit unit or a bit group that is a group of bits of bit 2) output by the optical DAC encoder 114 to the segments #4 to #7. By switching the switch 115, the signal is output to a different segment, for example, segments #1 to #4. Thus, the controller 118 has a function of arbitrarily switching between multiple input bit data and the segments to which those input bits are assigned.

Then, based on the monitoring results of segments #1 to #4 after the switch 115 has been switched, the controller 118 outputs the delay amount to be adjusted for segments #1 to #4 to the delay adjusting unit 116a. By repeating this process, timing adjustment is performed for all segments 122 while the device is in operation (data is being transmitted).

The delay adjusting unit 116a may perform timing adjustment using a general-purpose delay adjustment method. For example, when identical bit data is being output to the segments 122 to be adjusted for timing, the delay adjusting unit 116a sweeps the delay amount for the segments 122 to be adjusted for timing and determines the delay amount that maximizes the optical output. This minimizes the timing discrepancy between segments 122 to which identical bit data is being input.

In the embodiment, it is assumed that all segments 122 have the same length, i.e., the length L of the signal electrode along the optical waveguide (the delay amount between all adjacent segments 122 is the same). The controller 118 then controls the switch 115 to change the combinations of data and segments 122.

In the 3-bit, 7-segment configuration example described above for the optical DAC 100, the switch 115 switches a total of four outputs for the MSB bit 2 and thus, switches a majority of the total seven segments 122 of the optical modulator 121. This bit 2 may obtain a larger amplitude than the other bits 0 and 1 through four outputs, and the power thereof may be easily detected by the frequency filter 162 of the optical monitoring unit 117.

In the optical DAC 100 of the embodiment, the timing is continuously adjusted each time the switch 115 switches the combinations of the digital data of bits to be input to the segments 122 of the optical modulator 121 and the assigned segments 1222 to which the digital data is to be input. That is, the optical DAC 100 performs timing adjustment for multiple segments to which multiple bits of the same MSB data (in units of bit) are input. The optical DAC 100 then uses the switch 115 to switch the multiple data, which are in units of bit, and input the multiple data to multiple segments for which timing adjustment has not yet been performed. As a result, timing adjustment between all segments is performed in the background while the optical DAC 100 is in operation.

After delay calibration (initialization) performed at the time of factory shipment or installation, the optical DAC 100 of the embodiment dynamically adjusts the delay of the optical signal in real time, tracking voltage fluctuations during operation of the optical transmitter and temperature fluctuations due to local heat sources, etc.

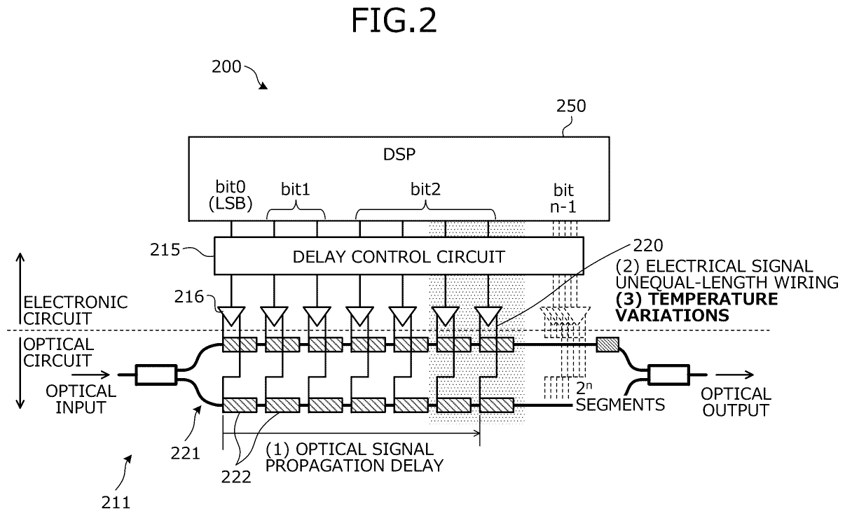

FIG. 2 is an explanatory diagram of factors that cause delays in optical DACs. With reference to FIG. 2, an existing technique related to timing adjustment for delays generated in optical DACs and issues thereof are discussed. A basic configuration of the optical DAC 200 depicted in FIG. 2 is the same as that of the embodiment (FIG. 1B).

The optical DAC 200 includes an optical modulator 211 configured with optical circuits, a DSP 250 configured with electronic circuits, a delay control circuit 215, and a driver 216. FIG. 2 depicts, for example, an n-bit configuration of the optical DAC 200. The n-bit data of bit 0 to bit n−1 output by the DSP 250 is coupled to the corresponding segments 222 of the optical modulator 211 via the signal wiring 220.

For the sake of explanation, it is assumed that bit 0 is a bit unit that outputs one bit of data (one lane), bit 1 is a bit unit that outputs the same bit data in two bits (two lanes), and bit 2 is a bit unit that outputs the same bit data in four bits (four lanes).

Signal delays of optical signals occur between the multiple segments 222 of the optical DAC 200 due to the following factors:

(1) In comparing the segments arranged on the optical waveguide 221 of the optical modulator 211, for example, with regard to the leftmost segment assigned to bit 0 and the rightmost segment assigned to bit 2, the segment assigned to bit 2 is delayed by the length of the optical waveguide depicted in the figure. Each segment experiences a propagation delay in this optical waveguide. The amount of propagation delay is proportional to the length of the optical waveguide. For lengths on the order of hundreds of micrometers to several millimeters, for example, the propagation delay is on the order of several picoseconds to several tens of picoseconds.

(2) Although the signal wiring 220 for electrical signals is depicted in the block diagram as having the same length for each segment, it is possible that the lengths of the segments may be unequal during circuit implementation. When wiring lengths become unequal, wiring delays may occur for each segment.

These propagation delays (1) and (2) are based on theoretical delays or design, etc., and are fixed delays, although they result in relatively large delay differences of several picoseconds to several tens of picoseconds. Therefore, delay correction may be performed using the delay control circuit 215 at the time of factory shipment or installation. To achieve good signal quality for the transmitted optical signal, a delay control circuit 215 that performs appropriate timing adjustments is necessary.

(3) Temperature variations occur in real time and thus, dynamic correction is necessary from a state where timing adjustments have already been made for the delay amounts (1) and (2) above. Dynamic timing adjustment is necessary to track voltage and temperature variations (e.g., local heat sources) in the optical DAC 200 during operation of the optical transmitter. For example, an electronic circuit simulator found that delay variations due to temperature variations from −5 degrees C. to 95 degrees C., assuming a certain driver circuit and delay circuit (no wiring, ideal conditions), were approximately 6 psec. Therefore, timing adjustments of several psec are expected to be necessary to accommodate temperature variations, etc. Furthermore, (3) temperature variations are variations occurring during operation and thus, so data transmission cannot be stopped and timing adjustments have to be made using data being transmitted during operation.

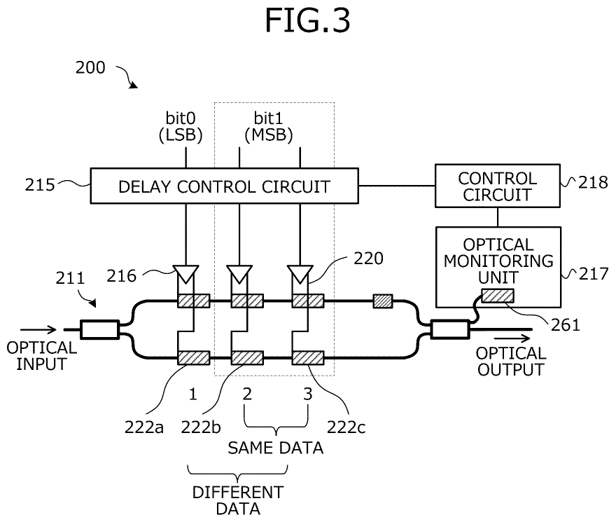

FIG. 3 is an explanatory diagram of an example of dynamic timing adjustment. FIG. 3 depicts an example of dynamic timing adjustment using an existing technique to address the temperature variation described above (3). For simplicity, a 2-bit optical DAC 200 is depicted.

The optical output of the optical modulator 211 is detected by the monitor PD 261 of the optical monitoring unit 217, and the detected power is output to the control circuit 218. The control circuit 218 adjusts the timing using the delay control circuit 215 based on the detected optical signal power.

With the configuration depicted in FIG. 3, even during operation of the optical DAC 200, timing adjustment is possible between segments 222b and 222c, to which the same data (MSB) bit 1 is input, even when different data (LSB) bit 0 is input to the other segment 222a.

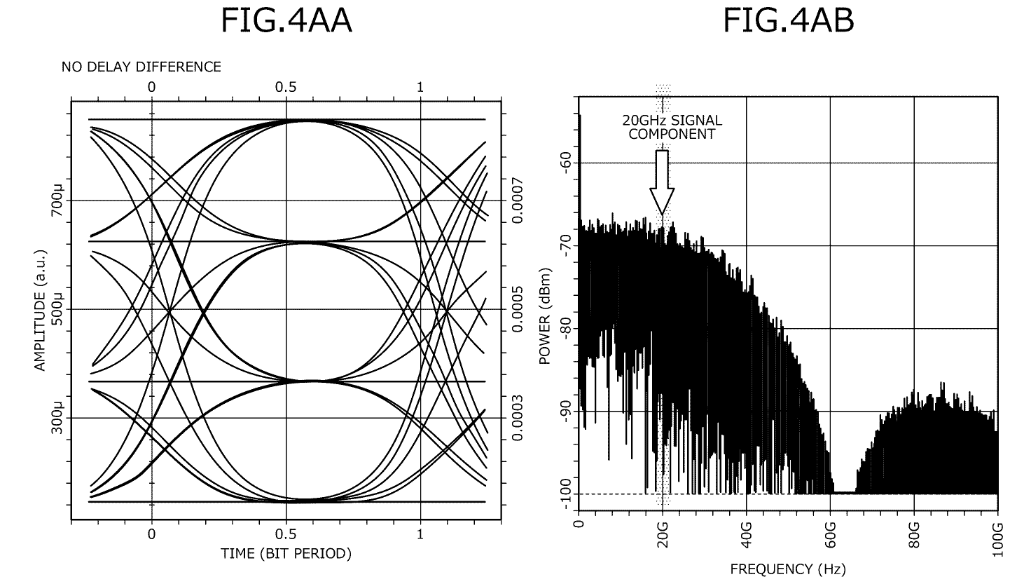

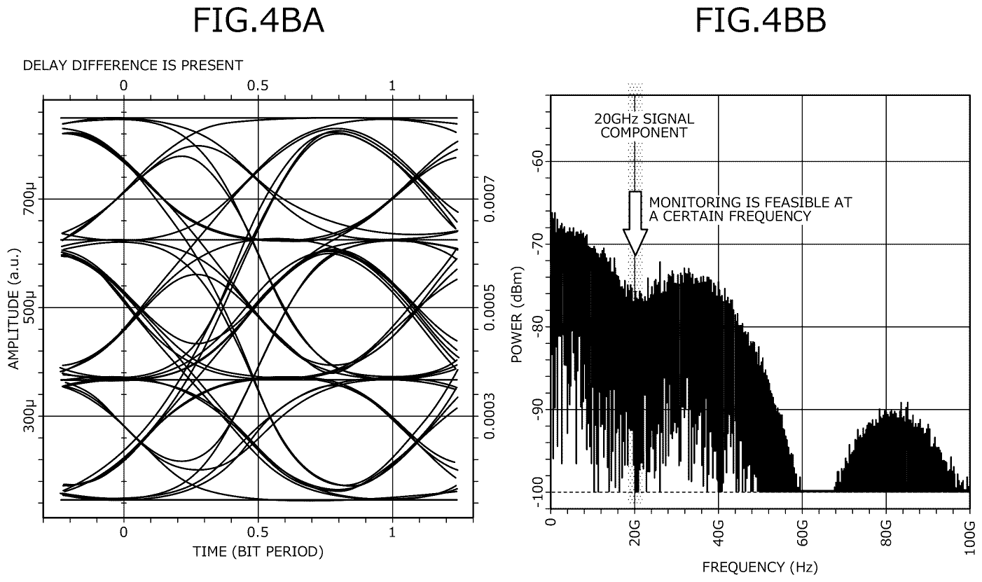

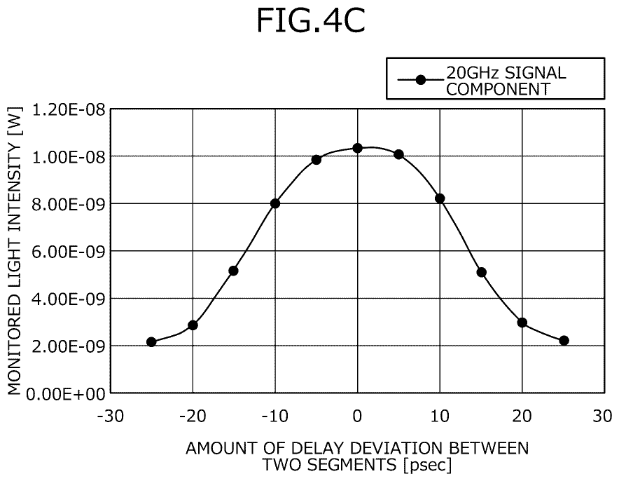

This timing adjustment during optical DAC operation is explained with reference to FIGS. 4AA to 4C. FIGS. 4AA, 4AB, 4BA, and 4BB are diagrams depicting examples of waveform degradation due to the presence or absence of signal delay. FIG. 4C is a graph depicting a relationship between the delay difference between segments receiving the same data and the monitored optical power. The horizontal axis of FIGS. 4AA and 4BA represents time, and the vertical axis represents amplitude. These graphs depict the changes in eye patterns when two bits, “bit 0” and “bit 1” in FIG. 3, are input to an optical DAC with three segments in pulse amplitude modulation 4 (PAM 4) signal transmission.

FIG. 4AA depicts a signal waveform in which the timing between segments 222a, 222b, and 222c is adjusted, resulting in a nearly uniform eye opening across the four levels. In contrast, FIG. 4BA depicts a signal waveform when there is a constant delay (timing difference) between segments 222b and 222c, and it can be seen that the eye waveform is degraded.

FIGS. 4AB and 4BB depict the frequency response of the optical output signal of the optical DAC 200, detected by the monitor PD 261 and converted into an electrical signal, with the horizontal axis representing frequency and the vertical axis representing optical power. In comparing FIG. 4AB, which depicts no timing difference, with FIG. 4BB, which depicts a timing difference, it is found that the 20 GHz optical power component is reduced in FIG. 4BB. In other words, optical power having a frequency component corresponding to the timing difference between the segments is reduced.

FIG. 4C depicts the results of monitoring the 20 GHz optical power component using, for example, a bandpass frequency filter for the delay difference between segments 222b and 222c and the output monitored component of the optical DAC 200. When the delay difference between the two segments is zero, the monitored value is maximized and may be adjusted within a range of +25 psec. That is, while monitoring this value, the delay adjustment circuit 215 sweeps the delay deviation between segments 222b and 222c, and timing adjustment is possible by applying the delay amount that maximizes the monitored value. While the results of extracting a 20 GHz optical power component using a bandpass frequency filter have been described above, the delay adjustment range may be changed by changing the frequency value extracted by this frequency filter. That is, by increasing the frequency filter value, the delay adjustment range may be narrowed, enabling highly accurate timing adjustment over a narrower range; by decreasing the frequency filter value, timing adjustment may be made over a wider delay adjustment range.

On the other hand, with this configuration, timing adjustment is not possible for segment 222a, to which LSB data is input, and segments 222b and 222c, to which MSB data is input. The reason for this is that timing adjustment using this method or conventional technique imposes data pattern restrictions, such as inputting identical or inverted data to the segments to be adjusted.

During operation of the optical DAC 200 depicted in FIG. 3, the bit data (bit 0) input to the LSB segment 222a is different from the bit data (bit 1) input to the MSB segments 222b and 222c. Therefore, timing adjustment between the LSB segment 222a and the MSB segments 222b and 222c is not possible. Thus, the existing technique does not allow timing adjustment for all segments of the optical DAC 200. While FIG. 3 depicts an example of two bits, the greater the number of bits, the greater the gap between segments (the number of segments) that cannot be adjusted using the existing technique.

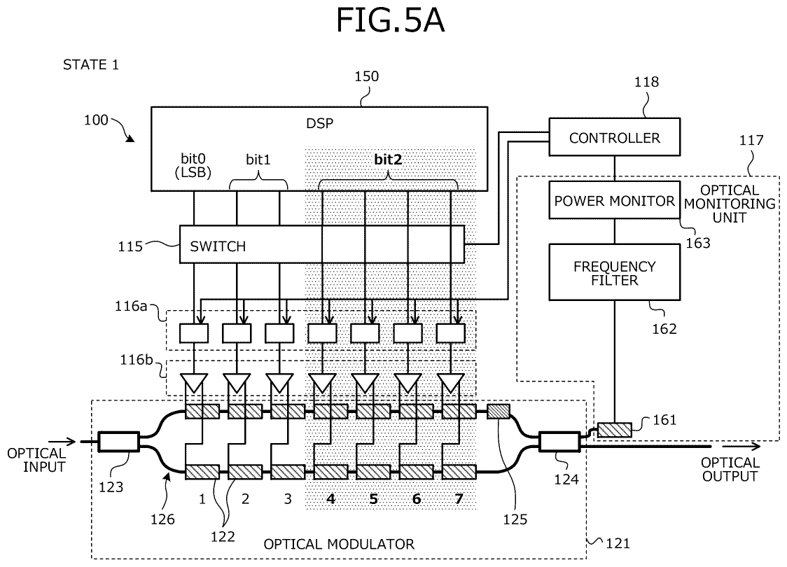

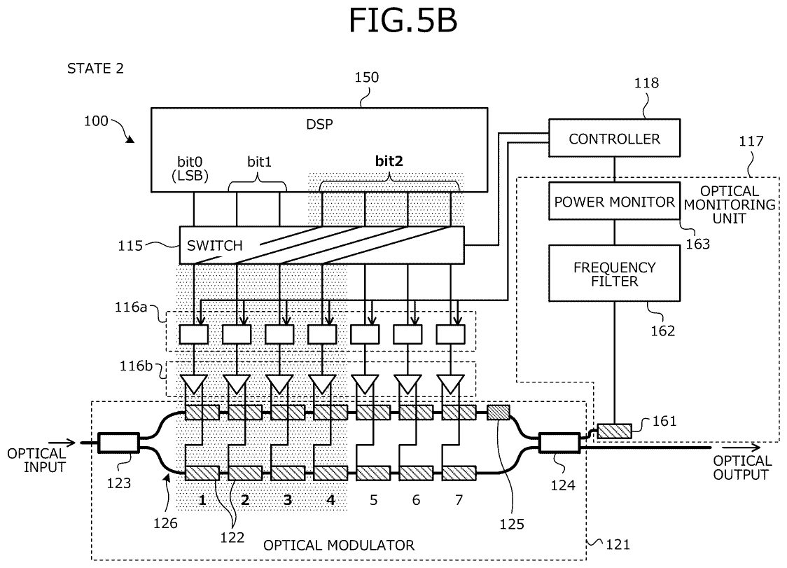

FIGS. 5A and 5B are explanatory diagrams of an example of timing adjustment for an optical DAC according to the embodiment. In response to the problems with the existing technique described in FIGS. 3 and 4AA to 4C, the optical DAC 100 according to the embodiment adjusts timing for all segments by switching the assignment of input bit data to multiple segments within the segment optical modulator during device operation.

For example, the controller 118 has a function of using the switch 115 to change the output path of the bit data driving each segment 122 (#1 to #7) between state 1 in FIG. 5A and state 2 in FIG. 5B. As a result, in state 1, the same data, MSB data, is input to segments 122 #4 to #7, enabling timing adjustment to be performed for segments #4 to #7. Furthermore, in state 2, MSB data is input to segments 122 #1 to #4, enabling timing adjustment to be performed for segments #1 to #4. As depicted in FIGS. 5A and 5B, bit 2, the most significant bit (MSB), accounts for a majority (4/7) of the total segments. Therefore, for example, in the optical monitoring unit 117, it is possible to monitor the optical power of a certain frequency component relative to the sweep of the delay amount as depicted in FIG. 4C, thereby enabling timing adjustment.

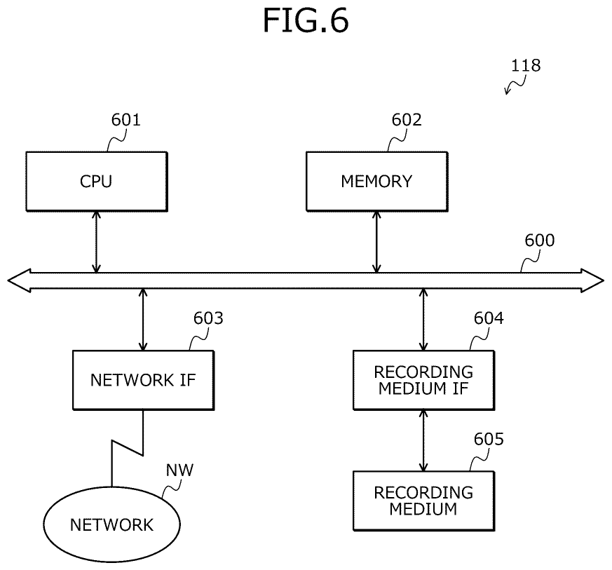

FIG. 6 is a diagram depicting an example of a hardware configuration of the controller of the optical DAC. The controller 118 of the optical DAC 100 depicted in FIG. 1 may be configured, for example, with the hardware depicted in FIG. 6.

For example, the controller 118 has a processor 601 such as a central processing unit (CPU), a memory 602, a network IF 603, a recording medium IF 604, and a recording medium 605. Furthermore, constituent parts are coupled to each other via a bus 600.

Here, the processor 601 is a controller that controls the entire controller 118. The processor 601 may have multiple cores. The memory 602 includes, for example, a read-only memory (ROM), a random access memory (ROM), and a flash ROM. For example, the flash ROM stores a control program, the ROM stores an application program, and the RAM is used as a work area of the processor 601. The programs stored in the memory 602 are loaded onto the processor 601, causing the processor 601 to execute encoded processes.

The network IF 603 serves as an interface between the network NW and the inside of the device, and controls the input and output of information between the device and the outside.

The recording medium IF 604 controls the reading and writing of data with respect to the recording medium 605 under the control of the processor 601. The recording medium 605 stores data written thereto under the control of the recording medium IF 604.

In addition to the components described above, the controller 118 may be coupled to, for example, an input device, a display, etc. via an IF.

The processor 601 depicted in FIG. 6 may implement the functions of the controller 118 depicted in FIG. 1 by executing a program.

The hardware configuration depicted in FIG. 6 is not limited to the controller 118 of the optical DAC 100 and may also function as the controller of an optical transmitter having the optical DAC 100. In this case, the processor 601 depicted in FIG. 6 controls each function of the optical transmitter.

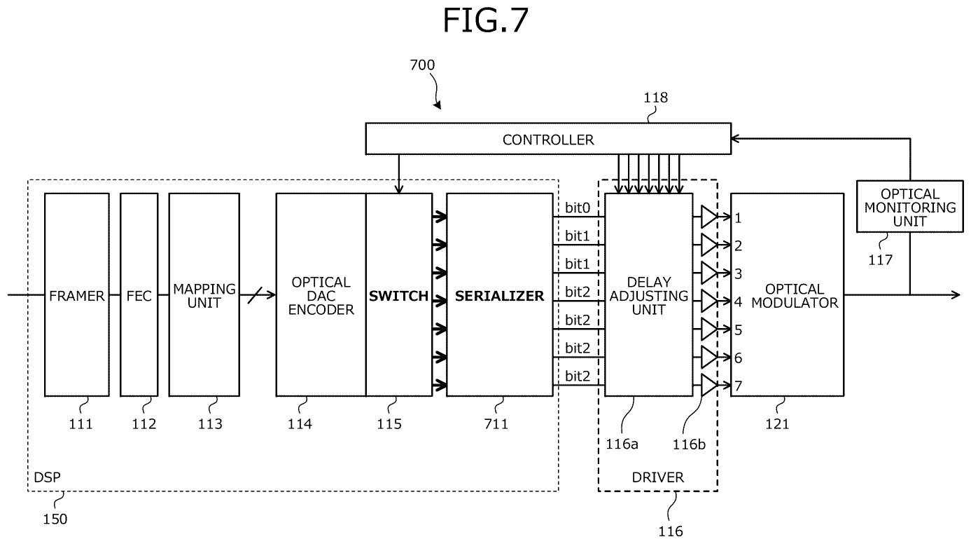

FIG. 7 is a functional block diagram depicting a configuration example of an optical DAC according to a first example. In an optical DAC 700 according to the first example, the function of the switch 115 that changes the combinations of data and segments is located within the DSP. The optical DAC 700 according to the first example also is an example of a 3-bit, 7-segment configuration, and the same components as those described above are designated by the same reference numerals as above.

The optical DAC 700 includes the DSP 150, the driver 116, the optical modulator 121, the optical monitoring unit 117, and the controller 118.

The DSP 150 includes the framer 111, the FEC 112, the mapping unit 113, the optical DAC encoder 114, the switch 115, and a serializer 711. The switch 115 is disposed downstream to the optical DAC encoder 114 and may switchably output a low-speed×n lanes data stream. For example, a 1 Gbps×64 lane data stream is output per lane. The number of lanes is determined by the ratio of the high-speed rate and the low-speed rate.

The serializer 711 converts (serializes) multiple lines of low-speed data (e.g., 64 lines) per lane into high-speed data and outputs the data to seven lanes, bit 0 to bit 2. The serializer 711 outputs data per lane to the driver 116 at a high rate (e.g., 64 Gbaud) equal to the system baud rate.

The optical DAC 700 of the first example has the switch 115 inside the DSP 150 and performs control digitally, thereby enabling data switching in units of one symbol or one sample. The controller 118 adjusts the timing of the four segments assigned to bit 2 and repeatedly changes the combinations of input bit data and the segments by switching the switches, thereby performing real-time timing adjustment during operation.

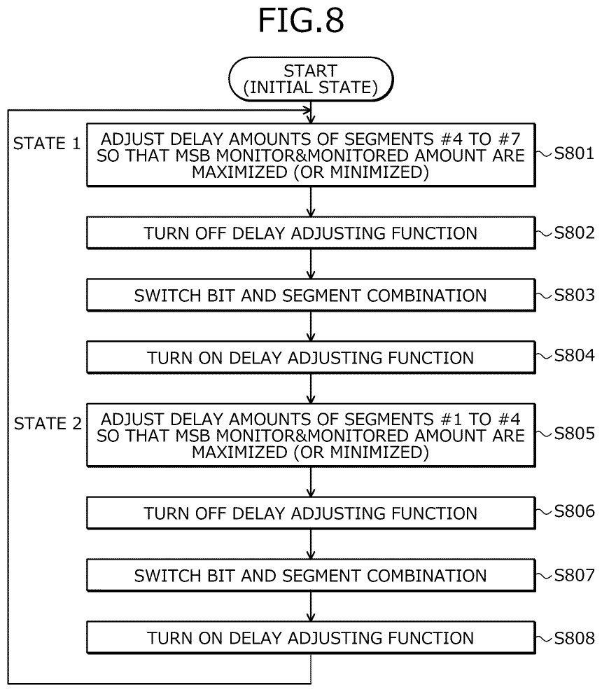

FIG. 8 is a flowchart of a first example of timing adjustment processing by the optical DAC of the first example. In the first example of timing adjustment processing, timing adjustment is performed in two different states, state 1 and state 2, described above. The processing depicted in FIG. 8 is performed by the controller 118 (CPU 601) controlling each function of the optical DAC 700.

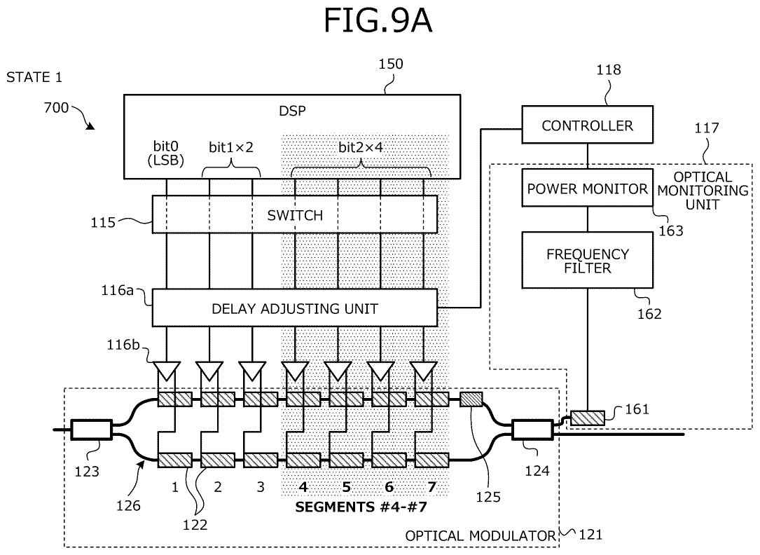

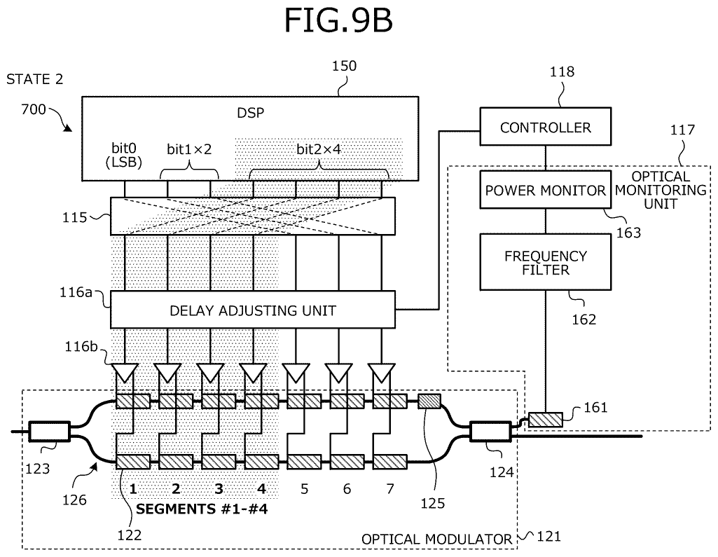

FIGS. 9A and 9B are diagrams depicting examples of combination states of bits and segments in the first example of timing adjustment processing of the first example. The first example of timing adjustment processing in FIG. 8 will be described with reference to FIGS. 9A and 9B.

After the initial calibration (pre-adjustment before shipping or at the device port) of the optical transmitter including the optical DAC 700 is completed and various settings such as all delays and bias states have been adjusted, the controller 118 continues the processing depicted in FIG. 8 in real time during operation. In the initial state, as depicted as state 1 in FIG. 9A, the switch 115 assigns bit 0 (LSB) output by the DSP 150 to segment #1, bit 1 to segments #2 and #3, and bit 2 (MSB) to segments #4 to #7.

Then, in state 1, the controller 118 observes the output power of the optical monitoring unit 117, which is the output of the optical modulator 121, and thus, may detect a deviation in the delay amount of the MSB (bit 2), the most significant bit with a large amplitude. The controller 118, using the delay adjusting unit 116a, then adjusts the delay amounts of segments #4 to #7 so that the monitored output power (the optical output power of the specified frequency component) is maximized (step S801). Details of this timing adjustment process will be described later.

After performing the delay amount adjustment at step S801 for a certain period of time, the controller 118 turns off the delay adjustment function of the delay adjusting unit 116a (step S802).

Next, the controller 118 switches the bit and segment combinations using the switch 115, to state 2 depicted in FIG. 9B (step S803). In state 2, the switch 115 performs switching so that bit 2 (MSB) output by the DSP 150 is assigned to segments #1 to #4. Segments #1 to #3 are segments whose timing was not adjusted at step S801. At this time, the switch 115 assigns, for example, the remaining bit 0 (LSB) to segment #5 and bit 1 to segments #6 and #7.

Then, in state 2, the controller 118 turns on a timing adjustment function of the delay adjusting unit 116a (step S804). Next, the controller 118 monitors the output power of the optical monitoring unit 117, which is the output of the optical modulator 121, and thereby monitors segments #1 to #4 assigned to MSB (bit 2). The controller 118 then adjusts the delay amount of segments #1 to #4 by the delay adjusting unit 116a so that the monitored output power (optical output power of the specified frequency component) is maximized (step S805).

After performing the delay adjustment at step S805 for a certain period of time, the controller 118 turns off the delay adjustment function of the delay adjusting unit 116a (step S806).

Thereafter, the controller 118 switches the bit and segment combination back to the original state 1 using the switch 115 (step S807), turns on the delay adjustment function of the delay adjusting unit 116a (step S808), and returns to the processing at step S801.

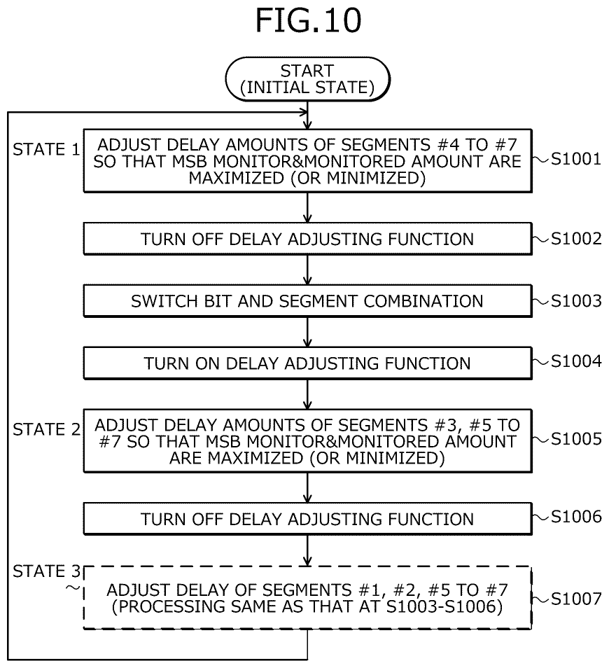

FIG. 10 is a flowchart of a second example of timing adjustment processing by the optical DAC of the first example. In the second example of timing adjustment processing, delay adjustment is performed one segment at a time. The processing depicted in FIG. 10 is performed by the controller 118 (CPU 601) controlling each function of the optical DAC 700.

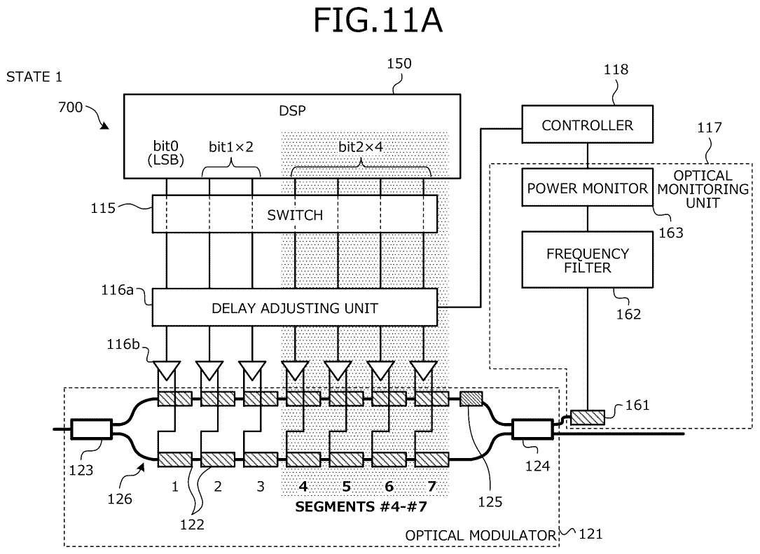

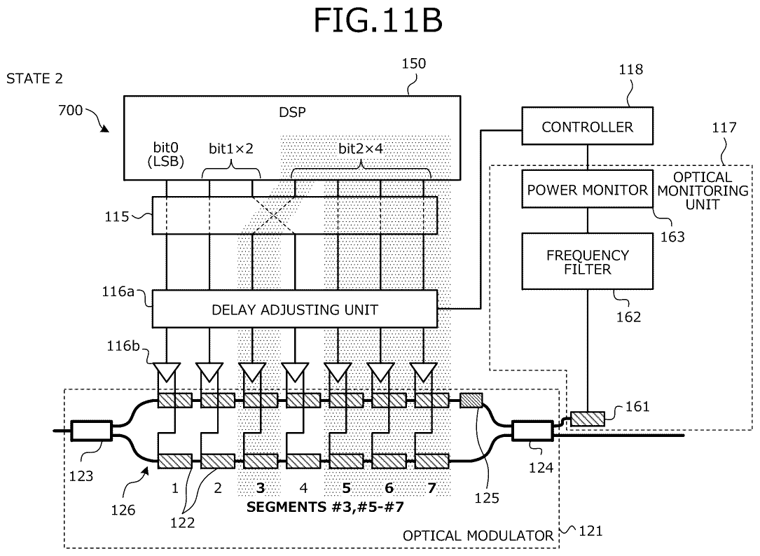

FIGS. 11A and 11B are diagrams depicting combination states of bits and segments in the second example of timing adjustment processing of the first example. The second timing adjustment processing depicted in FIG. 10 will be described with reference to FIGS. 11A and 11B.

The controller 118 continuously performs the processing depicted in FIG. 10 in real time during operation after the initial calibration (pre-shipment or advance adjustment at the device port) of the optical transmitter including the optical DAC 700 is completed and all settings, such as delay and bias state, have been adjusted. In the initial state, as depicted in FIG. 11A, the switch 115 assigns bit 0 (LSB) output by the DSP 150 to segment #1, bit 1 to segments #2 and #3, and bit 2 (MSB) to segments #4 to #7 (state 1).

The controller 118 then monitors segments #4 to #7 assigned to MSB (bit 2) by observing the output power of the optical monitoring unit 117 (the output of the optical modulator 121) and adjusts the delay amount of segments #4 to #7 using the delay adjuster 116a so that the (optical output power of the specified frequency component) is maximized (step S1001). Details of this timing adjustment process will be described later.

After performing the delay adjustment at step S1001 for a certain period of time, the controller 118 turns off the delay adjustment function of the delay adjusting unit 116a (step S1002).

Next, the controller 118 switches the bit and segment combinations using the switch 115 to the state depicted in FIG. 11B (step S1003). In the second example of timing adjustment processing, the segments to which the MSB is assigned are swapped one by one. Here, the switch 115 performs switching to swap the input data of segment #4 and segment #3 of bit 2 (MSB) output by the DSP 150 (state 2). In this state, segments #1 to #3 are segments whose timing has not been adjusted at step S1001.

Then, the controller 118 turns on the delay adjustment function of the delay adjusting unit 116a (step S1004). Next, the controller 118 may monitor segments #3, #5, #6, and #7 assigned to the MSB (bit 2) by observing the output power at the optical monitoring unit 117 (the output of the optical modulator 121) and use the delay adjusting unit 116a to adjust the delay amount of segment #3 so that the monitored output power (optical output power of the specified frequency component) is maximized (step S1005).

After performing the delay adjustment at step S1005 for a certain period of time, the controller 118 turns off the delay adjustment function of the delay adjusting unit 116a (step S1006).

Thereafter, the controller 118 performs timing adjustment for the next states 3 and 4, as in states 1 and 2, by swapping the MSBs one by one in the same manner as described above (step S1007). At step S1007, the same processing as that at steps S1003 to S1006 is performed. For example, in the next state 3, the same processing as that at steps S1003 to S1006 is performed for the remaining segment #2 for which delay has not been adjusted, the bit and segment combination is switched, and delay adjustment for segments #2, #5 to #7 is performed. Thereafter, in the next state 4, the same processing as that at steps S1003 to S1006 is performed for the remaining segment #1 for which delay has not been adjusted, the bit and segment combination are switched, and delay adjustment for segments #1, #5 to #7 is performed. Thereafter, the controller 118 returns to the processing at step S1001.

In the first and second timing adjustment processing examples of the first example, the combination of bits and segments may be switched at any time by the switch 115, and the time of the timing adjustment of the segment assigned to the MSB may be set to a predetermined time. Furthermore, in timing adjustment, when the switch 115 is switched, one or more pairs (two segments) of segments are swapped, and delay adjustment is performed for this pair of segments. Furthermore, the monitor may be kept on all the time, or may perform detection at regular intervals when the switch is switched. The delay adjustment processing described above is merely one example and is not limited to the first and second delay adjustment processing examples. Various other processes that change the combination of bits and segments may also be used to perform delay adjustment.

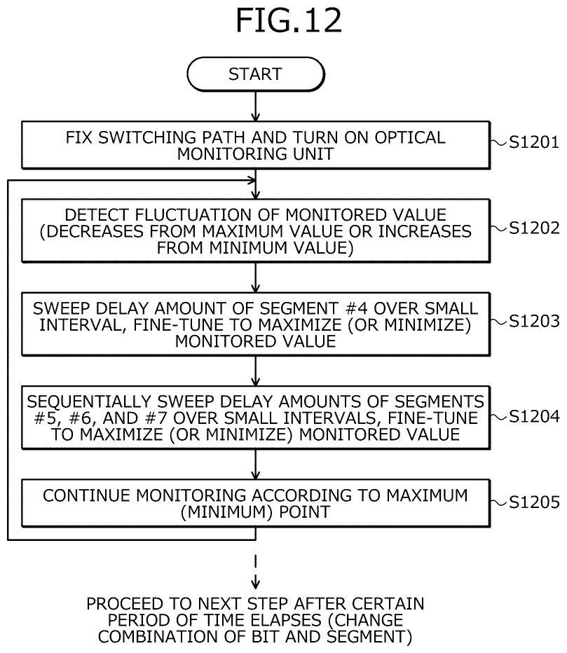

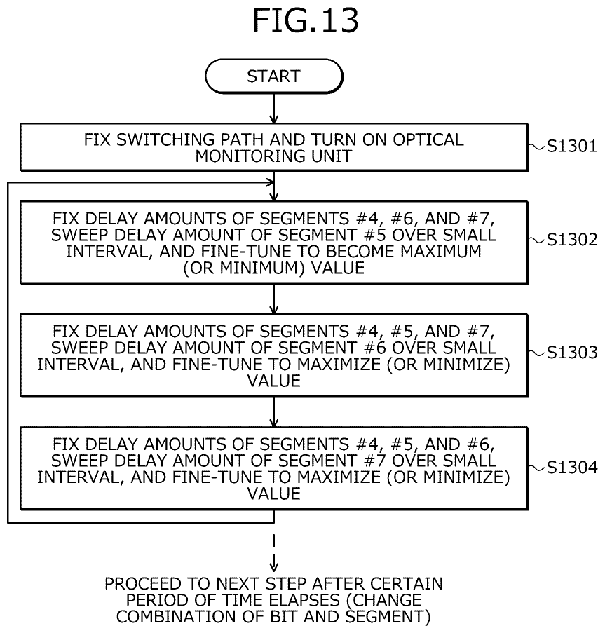

Specific processing examples of timing adjustment will now be described with reference to FIGS. 12 and 13. Here, specific examples of the processing at steps S801 and S805 of the first example of timing adjustment processing (FIG. 8) of the first example and steps S1001 and S1005 of the second example of timing adjustment processing (FIG. 10) of a second example will be described. This specific processing example corresponds to the specific example of delay amount adjustment described using FIGS. 4A to 4C.

FIG. 12 is a flowchart depicting a first specific processing example of timing adjustment. For simplicity of explanation, described herein is an adjustment of the delay amount for four segments #4 to #7 of the segments 122 to which the same bit data (e.g., MSB, bit 2) is assigned.

First, in a certain state (e.g., state 1), the controller 118 fixes the switching path of the switch 115 and turns on the optical monitoring unit 117 (step S1201). Next, the controller 118 detects for fluctuations in the monitored value of the optical monitoring unit 117 (step S1202). At this time, the controller 118 detects a decrease from the maximum value (or an increase from the minimum value) as a fluctuation in the monitored value. Here, for example, the maximum value means that the delay deviation between the segments in FIG. 4C is 0 psec when the timing between the segments is synchronized.

Next, the controller 118 sweeps the delay amount over a small interval for segment #4, for which delay adjustment is being performed, and fine-tunes the monitored value at this time to the maximum (or minimum) (step S1203). Here, the controller 118 performs control to sweep the delay amount after detecting a fluctuation in the monitored value.

Subsequently, the controller 118 also sweeps the delay amount over small intervals in turn for the other segments #5, #6, and #7, and fine-tunes the monitored value at this time to the maximum (or minimum) (step S1204).

Then, the controller 118 continues monitoring according to the maximum (or minimum) point (step S1205, refer to FIG. 4C). During the monitoring period, the controller 118 returns to the processing at step S1202 and continues the processing until the switch 115 is switched.

Note that the controller 118 proceeds to the next step after a certain period of time has elapsed. The step transition corresponds to when the switch 115 changes the combination of bits and segments. In this case, the controller 118 returns to the processing at step S1201.

FIG. 13 is a flowchart depicting a second specific processing example of timing adjustment. The second specific processing example is an example in which a certain segment is used as a reference and the segment to be subjected to delay adjustment is swept over a small interval to perform delay adjustment. For simplicity of explanation, FIG. 13 also describes timing adjustment for four segments #4 to #7 of the segment 122 to which the same bit data (e.g., bit 2, the MSB) is assigned.

First, in a certain state (e.g., state 1), the controller 118 fixes the switching path of the switch 115 and turns on the optical monitoring unit 117 (step S1301). Next, the controller 118 fixes the delay amounts of segments #4, #6, and #7, sweeps the delay amount of segment #5 (segment for which delay adjustment is being performed) over a small interval, and performs fine-tuning so that the monitored value at this time is maximized (or minimized) (step S1302).

Next, the controller 118 fixes the delay amounts of segments #4, #5, and #7, and sweeps the delay amount of segment #6 (segment for which delay adjustment is being performed) over a small interval and performs fine-tuning so that the monitored value at this time is maximized (or minimized) (step S1303).

Next, the controller 118 fixes the delay amounts of segments #4, #5, and #6, and sweeps the delay amount of segment #7 (segment for which delay adjustment is being performed) over a small interval and performs fine-tuning so that the monitored value at this time is maximized (or minimized) (step S1304).

Then, during the monitoring period, the controller 118 returns to the processing at step S1302 and continues processing until the switch 115 is switched.

Note that the controller 118 moves to the next step after a certain period of time has elapsed. The step transition corresponds to when the switch 115 changes the combination of bits and segments, and in this case, the controller 118 returns to the processing at step S1301.

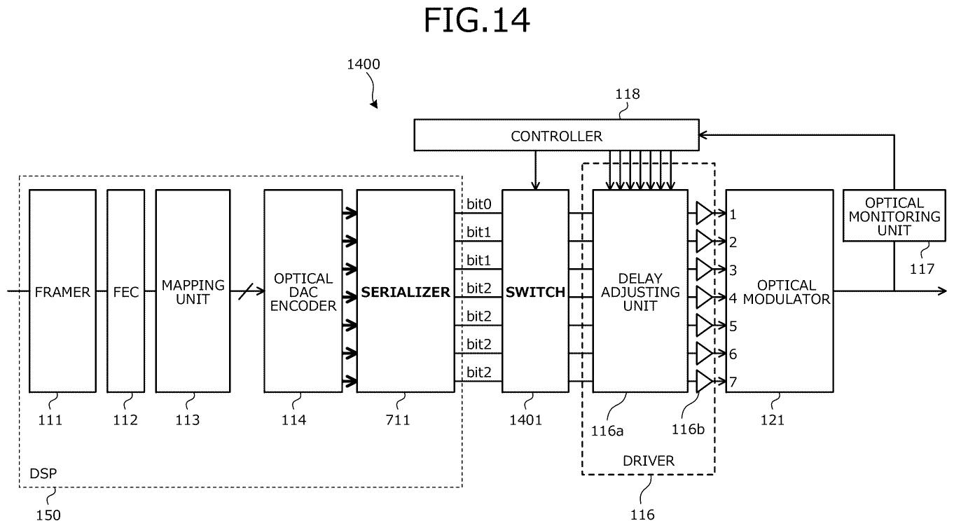

FIG. 14 is a functional block diagram depicting a configuration example of an optical DAC of the second example. In an optical DAC 1400 of the second example, the function of the switch that changes the assignment of input bit data and segments is located outside the DSP. The optical DAC 1400 of the second example also is a configuration example of 3 bits and 7 segments, and the same constituent elements as those described above are designated by the same reference numerals as above.

The optical DAC 1400 includes the DSP 150, the switch 1401, the driver 116, the optical modulator 121, the optical monitoring unit 117, and the controller 118.

The DSP 150 includes the framer 111, the FEC 112, the mapping unit 113, the optical DAC encoder 114, and the serializer 711.

The switch 1401 is disposed between the output of the DSP 150 (serializer 711) and the driver 116. The switch 1401 switches the paths for the seven lanes, bit 0 to bit 2, output by the serializer 711. The serializer 711 outputs data to the switch 1401 at a high rate per lane, the same as the system baud rate. For this reason, the switch 1401 has to be a circuit that quickly switches between combinations of the seven data bits, bit 0 to bit 2, and segments.

The optical DAC 1400 of the second example has the switch 1401 disposed outside the DSP 150, and switches between different bit data, for example, when the symbol (bit data) values between bit 0 and bit 1 become the same. By repeatedly changing the combinations of input bit data and assigned segments, real-time delay adjustment is implemented during operation.

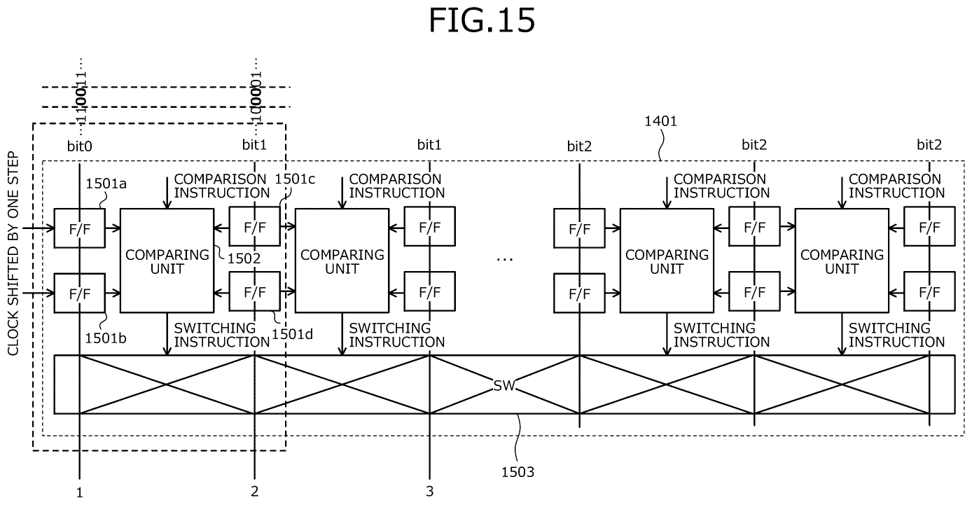

FIG. 15 is a circuit diagram depicting an example of a configuration of an optical DAC switch of the second example. To implement the switch 1401 for high-speed data, preferably configuration may be such that the output waveform is not affected when the switch 1401 is switched. In this regard, in the second example, high-speed switching is performed when different bit data, for example, symbols (bit data) between bit 0 and bit 1, are synchronized. For this reason, the switch 1401 of the second example is implemented using a logic circuit that detects multiple consecutive input symbols (for example, two or more) between different bits that are subject to lane switching upon switch switching, and a switching unit that switches bits and segments.

The switch 1401 includes multiple flip-flops (F/Fs) 1501 arranged between pairs of bit data, a comparing unit 1502, and a switching unit 1503.

The controller 118 issues a bit data comparison instruction to the F/Fs 1501 in the switches 1401 disposed in the two lanes to be swapped. Each of the F/Fs 1501 outputs the data of the lane thereof one step before and after the F/F 1501 and the data of the adjacent lane one step before and after, to the comparing unit 1502.

Two F/Fs 1501a and 1501b are arranged in lane #1 in FIG. 15, and these two F/Fs 1501a and 1501b receive clocks shifted by one step and each holds the input bit data shifted by one step. Two F/Fs 1501c and 1501d are arranged in lane #2, and the two F/Fs 1501c and 1501d each hold the input bit data shifted by one step based on the clocks shifted by one step.

The comparing unit 1502 outputs a switching instruction to the switching unit 1503 when the four input data are identical. For the other lanes, similar comparisons are made between the two lanes to be swapped, and switching control is performed.

For example, in FIG. 15, with regard to lane #1 for bit 0 and lane #2 (one of two lanes for bit 1), the bit data on lane #1 for bit 0 is “110011 . . . ”, and the bit data on lane #2 for bit 1 is “100001 . . . ”. Thus, during operation of the optical transmitter, different bit data is continuously input over time between bits 0 and 1 of the switch 1401 of the optical DAC 100.

The comparing unit 1502 outputs a switching instruction to the switching unit 1503 when the bit data values of the four F/Fs 1501a to 1501d are identical, for example, when the bit data values on lanes #1 and #2 are “00”. As a result, the switching unit 1503 switches (swaps) and outputs the data of bit 0 to lane #2 and the data of bit 1 to lane #1. As explained with reference to FIG. 15, bits and segments may be swapped between a pair of lanes with different bits 0 and 1.

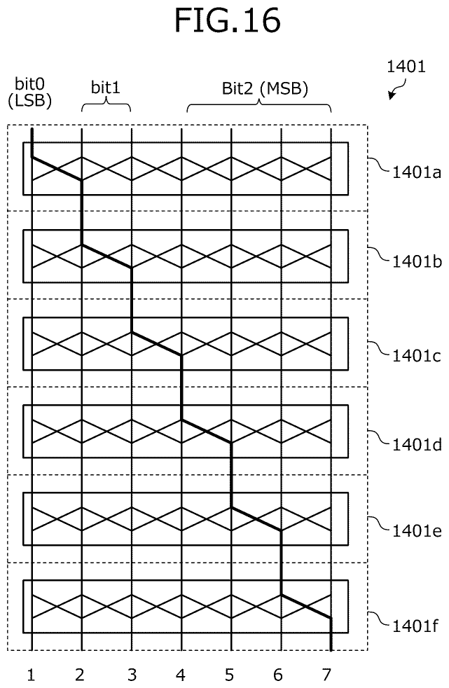

FIG. 16 is a diagram depicting an example of the configuration of a multi-stage arrangement of switches in an optical DAC according to the second example. The symbols in FIG. 16 correspond to the one-stage switch 1401 on the lane depicted in FIG. 15; and the one-stage switch 1401a swaps bit data between a pair of adjacent lanes. When swapping bit data across a total of seven lanes, each with 3 bits and 7 segments, six stages of switches 1401a to 1401f are arranged in multiple stages on the lane as depicted in FIG. 16, and the switches 1401a to 1401f in each stage sequentially swap the bit data between adjacent lanes. The number of stages of the switch 1401 is the total number of lanes minus one.

In FIG. 16, to output the bit data of bit 0 to segment #7 (lane #7), switches 1401a to 1401f arranged from top to bottom compare the bit data between adjacent bits and switch to the adjacent lane.

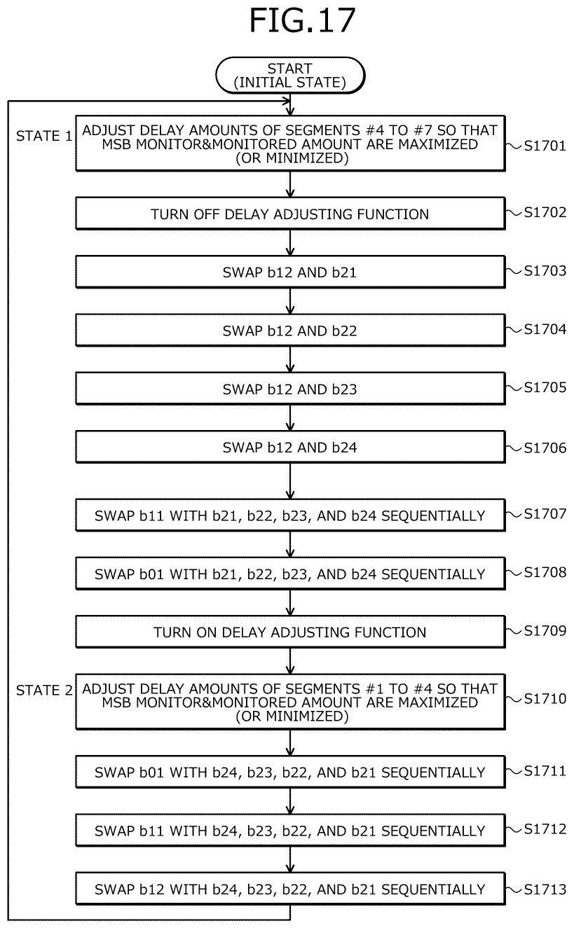

FIG. 17 is a flowchart of a first example of timing adjustment processing by the optical DAC of the second example. In the first example of timing adjustment processing, delay adjustment is performed in each of two states, state 1 and state 2. Thus, the controller 118 performs processing to sequentially swap the bit data between adjacent segments to change from state 1 to state 2. The controller 118 (CPU 601) controls each function of the optical DAC 1400 to perform the processes depicted in FIG. 17.

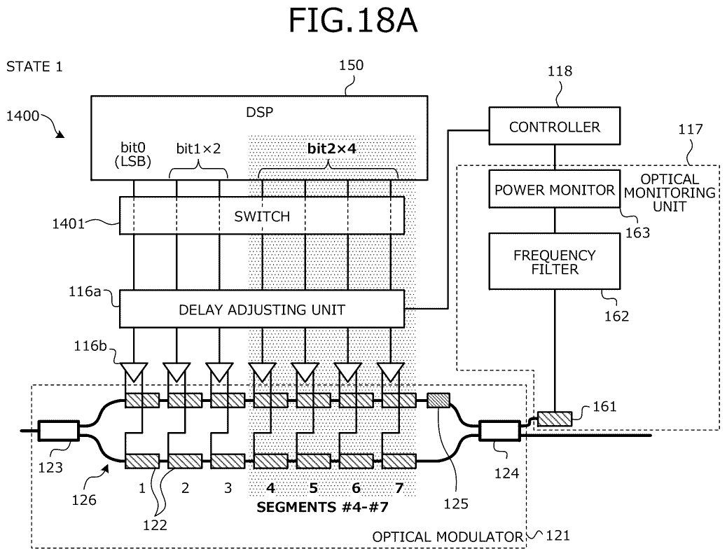

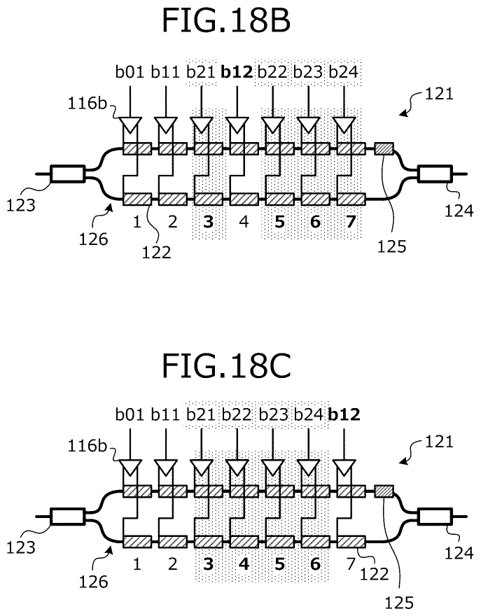

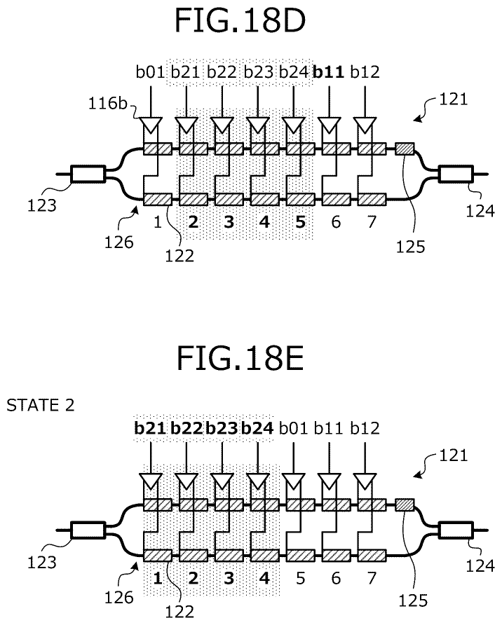

Also, FIGS. 18A, 18B, 18C, 18D, and 18E are diagrams depicting the switching states of bit and segment combinations in the first example of timing adjustment processing of the second example. The first example of the timing adjustment processing in FIG. 17 will be described with reference to FIGS. 18A to 18E.

The controller 118 continues to perform the processes in FIG. 17 in real time during operation after the initial calibration (pre-adjustment before shipping or at the device port) of the optical transmitter including the optical DAC 1400 is completed and all settings such as delay and bias state have been adjusted. In the initial state, depicted as state 1 in FIG. 18A, the switch 1401 assigns bit 0 (LSB) output by the DSP 150 to segment #1, bit 1 to segments #2 and #3, and bit 2 (MSB) to segments #4 to #7.

Further, in state 1, the controller 118 may monitor segments #4 to #7 assigned to the MSB (bit 2) by observing the output power (the output of the optical modulator 121) of the optical monitoring unit 117 and use the delay adjusting unit 116a to adjust the delay amount of segments #4 to #7 so that the monitored output power (optical output power of the specified frequency component) is maximized (step S1701). The specific delay adjustment process is the same as in the first example.

After performing the delay adjustment at step S1701 for a certain period of time, the controller 118 turns off the delay adjustment function of the delay adjusting unit 116a (step S1702).

Next, the controller 118, using the switch 1401, sequentially swaps bit data between adjacent lanes to switch the bit and segment combinations to state 2 depicted in FIG. 18E. In the state depicted in FIGS. 18A to 18E, segments #1 to #3 are segments whose timing has not been adjusted at step S1701.

In FIGS. 18A to 18E, each bit data is assigned a reference numeral and letters, with one bit 0 being b01, two bit 1s being b11 and b12, and four bit 2s being b21 to b24. Note that FIGS. 18B to 18E only depict the configuration of the optical modulator 121 and do not depict the DSP 150, the switch 1401, and so on.

First, as depicted in FIG. 18B, the controller 118, using the switch 1401, switches b12 and b21 (step S1703). Next, the controller 118, using the switch 1401, switches b12 and b22 (step S1704). Next, the controller 118, using the switch 1401, switches b12 and b23 (step S1705). Next, the controller 118, using the switch 1401, switches b12 and b24 (step S1706). At steps S1703 to S1706, the inter-segment detection and switching functions are sequentially turned on to switch the segments, and then turned off after the switching.

As a result, as depicted in FIG. 18C, it is possible to switch to a state in which b21 to b24 of bit 2 are output to lanes #3 to #6. At this time, b12 of bit 1 is output to lane #7.

Thereafter, the controller 118 similarly switches the bit data between adjacent lanes for b11 until state 2 is reached, that is, switches b11 with b21, b22, b23, and b24 sequentially (step S1707). This results in the switching state depicted in FIG. 18D.

Thereafter, the controller 118 similarly switches bit data between adjacent lanes for b01, i.e., switches b01 with b21, b22, b23, and b24 sequentially, until state 2 is reached (step S1708). This results in state 2, which is the bit and segment combination depicted in FIG. 18E.

Then, in state 2, the controller 118 turns on the delay adjustment function of the delay adjusting unit 116a (step S1709). Next, the controller 118 monitors the MSB (bit 2) and observes the output power of the optical monitoring unit 117 (the output of the optical modulator 121) and, thereby monitors segments #1 to #4 assigned to MSB (bit 2). The controller 118 then adjusts the delay amounts of segments #1 to #4 by the delay adjusting unit 116a so that the monitored output power (optical output power of the specified frequency component) is maximized (step S1710).

After performing the delay adjustment at step S1710 for a certain period of time, the controller 118 returns the bit and segment combinations to state 1. Thus, the controller 118 performs the bit data swapping between the adjacent lanes in reverse order.

The controller 118 swaps the bit data between adjacent lanes for b01, that is, swaps b01 with b24, b23, b22, and b21 sequentially (step S1711). Thereafter, the controller 118 swaps the bit data between adjacent lanes for b11, that is, swaps b11 with b24, b23, b22, and b21 sequentially (step S1712). Thereafter, the controller 118 swaps the bit data between adjacent lanes for b12, that is, swaps b12 with b24, b23, b22, and b21 sequentially (step S1713). As a result, the bit and segment combinations of state 1 depicted in FIG. 18A are obtained. Subsequently, the controller 118 returns to the process of step S1701.

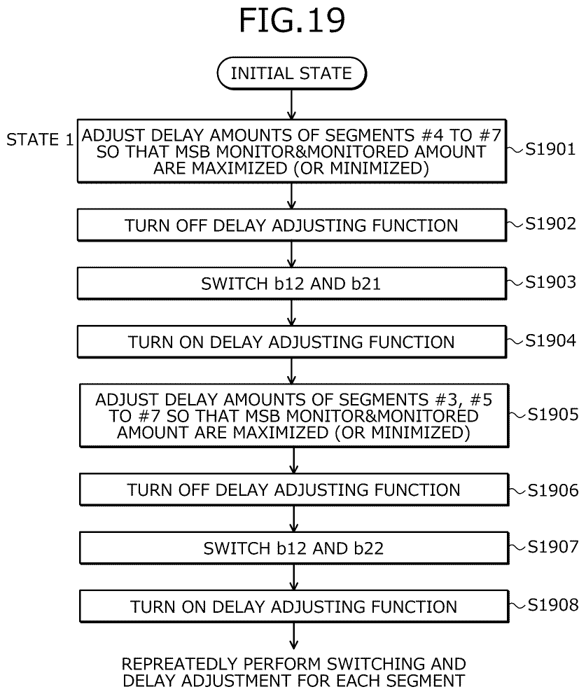

FIG. 19 is a flowchart of a second example of timing adjustment processing by the optical DAC of the second example. In the second example of timing adjustment processing, timing adjustment is performed between adjacent segments. The controller 118 (CPU 601) controls each function of the optical DAC 1400 to perform the processes depicted in FIG. 19.

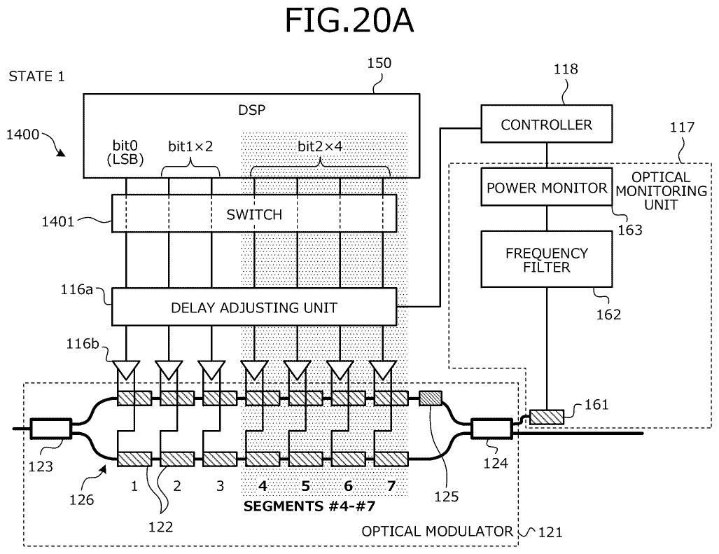

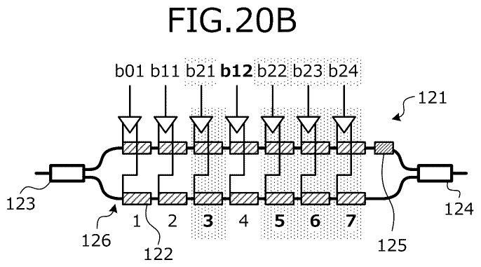

Also, FIGS. 20A and 20B are diagrams depicting the bit and segment combination states in the second example of timing adjustment processing of the second example. The second example of timing adjustment processing depicted in FIG. 19 will be described with reference to FIGS. 20A and 20B.

After the initial calibration (pre-adjustment before shipping or at the device port) of the optical transmitter including the optical DAC 1400 is completed and the initial state is reached in which all settings such as delay and bias state have been adjusted, the controller 118 continues the process depicted in FIG. 19 in real time during operation. In the initial state, as depicted as state 1 in FIG. 20A, the switch 1401 assigns bit 0 (LSB) output by the DSP 150 to segment #1, bit 1 to segments #2 and #3, and bit 2 (MSB) to segments #4 to #7.

In state 1, the controller 118 monitors the output power of the optical monitoring unit 117 (the output of the optical modulator 121) and thereby, monitors segments #4 to #7 assigned to MSB (bit 2). The controller 118, using the delay adjusting unit 116a, then adjusts the delay amounts of segments #4 to #7 so that the monitored output power (optical output power of the specified frequency component) is maximized (step S1901). A specific process for adjusting the delay amounts is the same as in the first example.

After performing the delay amount adjustment at step S1901 for a certain period of time, the controller 118 turns off the delay adjustment function of the delay adjusting unit 116a (step S1902).

Next, the controller, using the switch 1401, 118 switches bit data between adjacent lanes for bit-segment combinations. First, as depicted in FIG. 20B, the controller 118 switches bit b12 of bit 1 and bit b21 of bit 2 (step S1903). In the state depicted in FIG. 20B, segments #1 to #3 are segments whose delay amounts have not been adjusted.

Then, the controller 118 turns on the delay adjustment function of the delay adjusting unit 116a (step S1904). Next, the controller 118 monitors the output power of the optical monitoring unit 117 (the output of the optical modulator 121) and thereby, monitors segments #3, #5 to #7 assigned to the MSB (bit 2). The controller 118, using the delay adjusting unit 116a, then adjusts the delay amount of segment #3 so that the monitored output power (optical output power of the specified frequency component) is maximized (step S1905).

After performing the delay adjustment at step S1905 for a certain period of time, the controller 118 turns off the delay adjustment function (step S1906) and switches b12 of bit 1 and b22 of bit 2 (step S1907).

The controller 118 then turns on the delay adjustment function of the delay adjusting unit 116a (step S1908). Thereafter, similar to the above processes, lane switching and delay adjustment are repeatedly performed segment by segment for segments #2 and #1 whose delay amounts have not been adjusted.

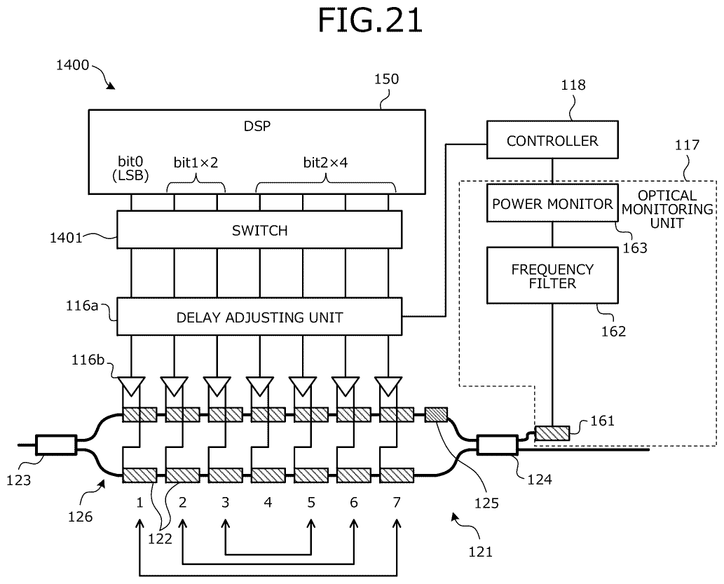

FIG. 21 is a diagram depicting a third example of timing adjustment processing using the optical DAC in the second example. While the above description has been given of switching (swapping) the combinations of bits and segments between a pair of adjacent segments, in the third example of timing adjustment processing, the combinations of bits and segments are switched between a pair of non-adjacent segments.

As depicted in FIG. 21, bit data may be swapped between segments #1 and #7, segments #2 and #6, and segments #3 and #5, with segment #4 at the center, to obtain bit and segment combinations for each of states 1 and 2. According to the third example of timing adjustment processing, a simple configuration is possible using only the single-stage switch 1401.

In the above description of the second example, the optical DAC controller 118 is configured to detect the timing at which symbols (bit data) become identical multiple times between different bits during operation. Assuming that the bit data is a pseudo-random binary sequence (PRBS), the frequency at which symbols become identical multiple times between a pair of bits (twice in the example depicted in FIG. 15) is sufficient.

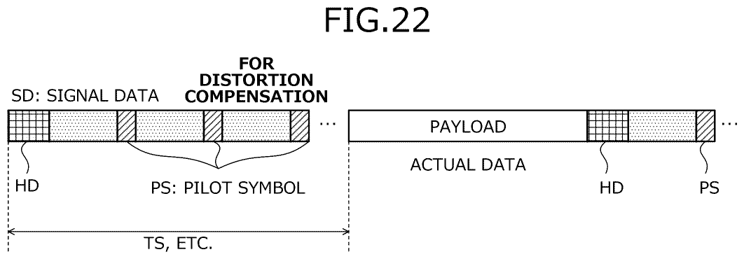

FIG. 22 is a diagram depicting an example of switching timing detection by the optical DAC in the second example. FIG. 22 depicts a transmission data format, with the transmission data SD including a training sequence (TS) containing a header HS at the beginning and a payload in which actual data is stored. For example, in typical digital coherent transmission, the transmission data SD may be several tens of thousands of symbols in total, and the TS may be several hundred symbols.

In this case, assuming transmission data of several tens of thousands of symbols at 64 Gbaud, the period is on the order of several hundred nanoseconds. The optical DAC 1400 may prepare a series of known signals at intervals of several hundred nanoseconds to several microseconds in advance and insert the prepared series of known signals into the transmission data SD.

Furthermore, the optical DAC 1400 of the second example may insert a series of known signals within the TS. For example, the known signals may be inserted into the training sequence.

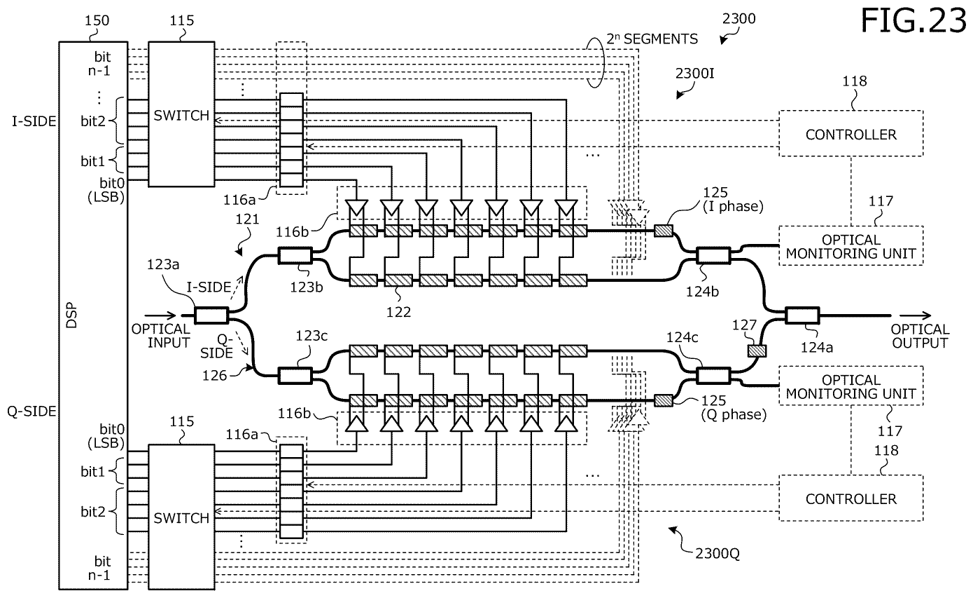

FIG. 23 is a diagram depicting an example of the configuration of an optical DAC with a coherent configuration. This optical DAC 2300 receives IQ data as input to the DSP 150, has an I-side circuit 23001 and a Q-side circuit 2300Q that are symmetrical downstream of the DSP 150, and generates and outputs coherent light. The I-side circuit 23001 and the Q-side circuit 2300Q each include the switch 115 and the driver 116 (the delay adjusting unit 116a and the binary driver array 116b). In FIG. 23, while the same components as those in the first example (FIG. 1) are denoted by the same reference numerals used in FIG. 1, the configuration of the second example is also applicable, and the switch 1401 of the second example may be used instead of the switch 115.

In the IQ configuration, three demultiplexers 123 are disposed at the optical input section of the optical modulator 121 on the optical circuit side, the two-branch demultiplexer 123a demultiplexing the signal into I and Q sides, and the I-side demultiplexer 123b further demultiplexing the signal into two, and the Q-side demultiplexer 123c further demultiplexing the signal into two. Furthermore, three multiplexers 124 are disposed at the optical output section, the I-side demultiplexer 124b multiplexing two signals, the Q-side demultiplexer 124c multiplexing two signals, the multiplexer 124a multiplexing and outputting the I and Q sides. Furthermore, the DC phase shifter 125 controls the phase of each of the I and Q sides with a DC bias. Furthermore, a DC phase shifter 127 for bias control between the I and Q sides is disposed between the multiplexers 124c and 124a.

Thus, by arranging a pair of optical the DACs described in the first and second examples on the I and Q sides, an optical transmitter that performs coherent transmission may be configured. By arranging the I-side circuit 23001 and the Q-side circuit 2300Q symmetrically in the optical DAC 2300, delay adjustment may be performed for each of the I-side and Q-side of the coherent light.

The optical transmitter of the embodiment described above includes an optical modulator having three or more segments arranged in series along one or both of the two optical waveguides of the Mach-Zehnder interferometer, two or more types of input bit data (corresponding to the optical DAC) being input to the segments of the optical modulator, an encoder that outputs to the segments, multiple bits of bit data obtained by converting the input bit data to code for optical modulation by the optical modulator, a switch that may switch the bit data output by the encoder to a different segment, and a delay adjusting unit that adjusts the delay amount between the segments. The controller of the optical DAC instructs the switch to switch the bit data output by the encoder to a different segment and notifies the switch of the delay amount for the delay adjusting unit, based on monitoring the optical signal after optical modulation by the optical modulator. As a result, even during operation of the optical transmitter, in which bit data with different values for each bit is continuously input, bit data for which delay is adjustable may be output to a segment for which delay adjustment has not been performed, by switching the switch, thereby making it possible to adjust the delay amount.

In the optical transmitter of the embodiment, the controller controls the switch to switch bit data that outputs at least two or more identical data among multiple bits, to a segment for which delay adjustment has not been performed, the bit data being switched on a bit-by-bit basis. For example, the controller controls the switch to switch multiple bit data of the MSB on a bit-by-bit basis. As a result, adjustment of the delay between a pair of segments is facilitated.

The optical transmitter of the embodiment may have a serializer that converts the encoder output rate to baud-rate data, and the switch may be located before the serializer. In this case, the switch may be switched at a low rate before serialization.

The optical transmitter of the embodiment may have a serializer that converts the encoder output rate to baud-rate data, and the switch may be located after the serializer. In this case, the switch may be configured to support a high-speed rate after serialization.

In the optical transmitter according to the embodiment, the controller may perform delay adjustment between adjacent segments for which delay adjustment has not been performed in each of different states before and after switching bit data to different segments on a bit-by-bit basis, using the switch. Thus, by switching the switch on a bit-by-bit basis, delay adjustment for all segments may be easily performed.

In the optical transmitter according to the embodiment, the controller may perform delay adjustment between adjacent segments for which delay adjustment has not been performed while switching bit data to different segments on a bit-by-bit basis using the switch. As described, when switching the switch on a bit-by-bit basis, delay adjustment for all segments may be performed by performing delay adjustment between corresponding segments each time one bit of data is switched.

In the optical transmitter according to the embodiment, the controller may output an instruction to the switch to switch the data between corresponding segments when detecting that bit data of different bits input to segments have the same value for a predetermined number of consecutive times. This makes it possible to easily switch segments and perform delay adjustment between segments for which the same value is output.

In the optical transmitter of the embodiment, a predetermined number of consecutive identical values may be inserted as a known signal into part of the input transmission data, and the controller may detect the predetermined number of consecutive identical values. For example, the known signal may be inserted into a training sequence of the transmission data. This makes it possible to easily detect a state in which different bits of data input to a segment have the same value for a predetermined number of consecutive bits.

The optical transmitter of the embodiment may have an optical DAC including an optical modulator, an encoder, a switch, a delay adjusting unit, and a controller in each of the I-side circuit and Q-side circuit thereof, and may output coherent light. By symmetrically arranging the I-side circuit and the Q-side circuit in the optical DAC, it becomes possible to perform delay adjustment for each of the I-side and Q-side of the coherent light.

According to one aspect of the present disclosure, an effect of enabling the timing of all segments to be adjusted during operation is achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmitter comprising:
an optical modulator that modulates an optical signal, the optical modulator having three or more segments arranged in series along one or both of two optical waveguides of a Mach-Zehnder interferometer, two or more types of input bit data being input to the three or more segments of the optical modulator;
an encoder that obtains bit data for a plurality of bits by converting the input bit data to code for optical modulation performed by the optical modulator, the encoder outputting the obtained bit data to any of the three or more segments;
a switch that switches the bit data output by the encoder to a different one of the three or more segments;
a delay adjusting unit that adjusts an amount of delay between the three or more segments; and
a controller that instructs the switch to switch the bit data output by the encoder to the different one of the three or more segments and notifies the switch of an amount of delay for the delay adjusting unit, based on monitoring of the optical signal optically modulated by the optical modulator.

2. The optical transmitter according to claim 1, wherein
the bit data includes first bit data for two or more of the plurality of bits and having identical data, and
the controller controls the switch to switch, on a bit basis, the first bit data to a segment free of delay adjustment by the delay adjusting unit.

3. The optical transmitter according to claim 2, wherein
the bit data includes a plurality of second bit data for a most significant bit, and
the controller controls the switch to switch, on a bit basis, the plurality of second bit data.

4. The optical transmitter according to claim 1, comprising:
a serializer that converts an output rate of the encoder into baud rate data, wherein
the switch is disposed upstream to the serializer.

5. The optical transmitter according to claim 1, comprising:
a serializer that converts an output rate of the encoder into baud rate data, wherein
the switch is disposed downstream to the serializer.

6. The optical transmitter according to claim 1, wherein
the controller adjusts the delay between adjacent segments that, of the three or more segments, are free of delay adjustment by the delay adjusting unit, the controller adjusting the delay between the adjacent segments in each of different states before and after the switch switches the bit data to the different one of the three or more segments.

7. The optical transmitter according to claim 1, wherein
the controller adjusts the delay between adjacent segments that, of the three or more segments, are free of delay adjustment by the delay adjusting unit, the controller adjusting the delay between the adjacent segments while the switch is switching the bit data to the different one of the three or more segments.

8. The optical transmitter according to claim 5, wherein
the controller outputs an instruction to the switch to swap the bit data between any of the three or more segments, when detecting that the bit data input to the any of the three or more segments have identical values a predetermined number of times consecutively and are for different bits of the plurality of bits.

9. The optical transmitter according to claim 8, wherein
a predetermined number of consecutive identical values are inserted in advance as a known signal into input transmission data, and
the controller detects the consecutive identical values.

10. The optical transmitter according to claim 9, wherein
the known signal is inserted in a training sequence of the transmission data.

11. The optical transmitter according to claim 1, comprising:
an optical DAC having an I-side circuit and a Q-side circuit that each include the optical modulator, the encoder, the switch, the delay adjusting unit, and the controller, the optical DAC emitting coherent light.

12. A timing adjustment method for an optical modulator having three or more segments arranged in series along one or both of two optical waveguides of a Mach-Zehnder interferometer, and an optical transmitter that outputs an optical signal based on two or more types of input bit data input to the three or more segments of the optical modulator, the method comprising:
obtaining bit data for a plurality of bits by converting the input bit data to code for optical modulation performed by the optical modulator, and outputting the obtained bit data to any of the three or more segments, by an encoder;
adjusting an amount of delay between the three or more segments, by a delay adjusting unit; and
by a controller, instructing a switch to switch the bit data output by the encoder to a different one of the three or more segments and notifying the switch of an amount of delay for the delay adjusting unit, based on monitoring of the optical signal optically modulated by the optical modulator.
